(19) United States
(12) Patent Application Publication
(10) Pub. No.: US 2017/0172160 A1
(43) Pub. Date: Jun. 22, 2017

(54) TORTILLA PRODUCT AND METHOD

(71) Applicants: Jose Magana, Lawrenceville, GA (US); Antonio Magana, Lawrenceville, GA (US)

(72) Inventor: ANTONIO MAGANA, Lawrenceville, GA (US)

(21) Appl. No.: 14/978,259

(22) Filed: Dec. 22, 2015

(51) Int. Cl. A21D 13/00; A21D 8/02

(52) U.S. Cl. CPC A21D 13/0074; A21D 8/02; A21D 13/0096

(57) ABSTRACT

A tortilla formed by a process that includes scraping at a least a layer of dough from the dough form used to prepare the tortilla, and a fried tortilla product formed using the same. The process yields a fried product that exhibits an unexpectedly different surface profile and texture as well as enhanced flavor.

### TECHNICAL FIELD

The invention of this application relates to the field of tortilla products and snack foods, as well as to methods of making such products. In particular the invention relates to methods of making tortillas and preparing fried tostadas or other fried tortilla products by application of a novel processing method to dough forms prepared from nixtamalized maize.

### BACKGROUND

The products of the invention are in the field of tortillas and fried tortilla products such as tostadas and tortilla chips. The word “tostada” typically refers to a flat tortilla that is deep fried or toasted. Corn tortillas are usually used for tostadas, although tostadas made of wheat flour may also be found. The tostada was originally developed to make use of tortillas that were not fresh enough to be made into tacos but were still fresh enough to be eaten. Generally, the process of preparation involves frying the tortilla in hot oil. Commercial tostadas which are comparable in consistency and taste to tortilla chips are commonly sold snack foods.

A recognized problem in the preparation of tortilla products, including tostadas, is the phenomenon of delamination, which causes puffing beneath the surface of the tortilla dough as it is fried. This delamination can cause the product texture to be flaky and therefore unstable, and it also creates an undesirable bubbled appearance on the exterior surfaces of the final product. Delamination has been a recognized unfavorable characteristic of tortilla manufacture. See, e.g. U.S. Pat. No. 4,931,303. Several efforts have been made to reduce delamination, such as baking, control of the moisture content in the dough or changing the ingredient formulation to generate a delamination resistant dough.

### SUMMARY OF INVENTION

In one aspect the invention comprises a method of making a tortilla product that includes formulating a dough that includes a flour ingredient, for example a flour formed from corn or other grains; shaping and flattening the dough into a dough form comprised of a first lamellar surface, a second lamellar surface and a central stratum between the first and second lamellar surfaces; semi-cooking the dough form, e.g. by baking rapidly; scraping at least a layer from the first lamellar surface of the dough form, thereby forming a scraped surface.

In a further aspect, the inventive concept comprises subjecting the scraped dough form to a pre-frying treatment; and then frying the dough form. The resulting fried tortilla product comprises a roughened surface profile on one side and a typical compressed surface on the other side. At the same time the product surface lacks the delamination that has been observed and even found to be undesirable in conventionally made tortilla products.

In another aspect the invention comprises a modified tortilla product formed according to the process of the invention. This product differs from conventional fried tortilla products in physical characteristics such as surface profile, texture, brittleness and texture, as well as flavor, when compared to conventional products. In this respect the product of the invention comprises a substantially uniformly roughened surface on at least one side thereof that has been formed by scraping and dehydrating at least one exterior lamellar surface of a semi-cooked dough form. The scraped, semi-cooked dough form is subjected to one or more pre-frying treatments and then fried. The resulting product is characterized by a crisp, non-greasy texture and a uniformly roughened surface profile without delamination on the side of the tortilla that was scraped. This fried product has an enhanced flavor profile and a crisper texture than products made by frying conventional tortillas.

### BRIEF DESCRIPTION OF DRAWINGS

FIG. 1 is a flow diagram summarizing the essential process steps of the invention.

FIG. 2 is a photographic image of a cross section of a dough form prepared according to the invention that has been scraped but not yet dried (scale 1:250 μm).

FIGS. 3A and 3B are photographs of cross sections of dough forms according to the invention after the dough form has been air dried (scale 1:250 μm).

FIG. 4 is a photographic image of a section of the surface of the scraped side of an undried dough form according to the invention (1:5 mm).

FIG. 5A is a standard resolution photographic image of the unscraped surface of a tortilla product prepared according to the invention.

FIG. 5B is a standard resolution photographic image of the scraped surface of a fried tortilla product prepared according to the invention.

FIGS. 6A and 6B are further resolved photographic images of the unscraped and scraped surfaces, respectively, of a fried tortilla product prepared according to the invention showing the surface textures in magnification.

FIGS. 7A and 7B are standard resolution photographic images of the respective first and second surfaces of a conventional packaged tortilla that has been dried but not fried.

FIGS. 8A, 8B and 8C are magnified cross-sectional images of a fried tortilla product according to the invention (scale 1:250 μm).

FIG. 9 is a photographic image of the surface of a conventional tortilla product (scale 1:500 μm).

FIG. 10 is a photographic image of the surface of a fried tortilla product of the invention (scale 1:250 μm).

FIG. 11 is a cross sectional image of a conventional, commercially marketed par-baked and dried tortilla (scale 1:250 μm).

FIG. 12 is a standard resolution photographic image of the surface of a fried conventional tortilla.

FIG. 13 is a photographic image of a section of the surface of the scraped side of a fried tortilla product of the invention (scale 1:500 μm).

FIG. 14 is a photographic image of a section of the surface of the scraped side of a fried tortilla product of the invention (scale 1:500 μm).

### DESCRIPTION OF EMBODIMENTS

The modified tortilla product formed according to the process of the invention is characterized by a surface profile that has not heretofore been observed in fried tortilla products. The process does not create bubbling or delamination as is observed in conventional tortilla products. The process also results in more intense and favorable flavor characteristics in the finished product.

The phenomenon of delamination is recognized as a common yet undesirable feature of tortilla products that have been rolled or sheeted and then baked or fried. In this regard, the term “delamination” may be interpreted according to the following description. In the sheeting process, pockets of air are trapped in the interior of the sheeted dough. As the sheeted dough is cooked, usually at baking or frying temperatures, the trapped air expands and creates bubbles beneath the outer surface of the dough. Usually these bubbles can range in diameter from about 0.5mm to about 5 mm. The bubbles separate the sheeted dough into multiple layers that create areas of expansion just beneath the surface of the dough. Accordingly, in a typical tortilla frying process, the resulting surface after cooking a conventional tortilla remains relatively smooth, but the smoothness on either side of the cooked product is interspersed by bubbling in which the region of dough over each bubble is elevated in relation to the remainder of the smooth surface. Delamination has until now been a commonly observed and undesirable problem for commercial and non-commercial manufacturers of snack foods, such as tostadas or masa-based chip products. Manufacturers have investigated ways to limit the bubbling of the dough during frying. This problem is solved by the innovative process of the present invention.

Delamination has been observed to be affected by physical properties including the moisture content and thickness of the sheeted dough, the presence or absence of large particulate materials, and cohesiveness, which allows the dough to stretch uniformly when the bubbles are being formed during frying. Preferably, the moisture content for bubble formation is from about 30% to about 55% by weight, more preferably from about 35% to about 45% by weight. Thickness of the dough form also affects delamination, and it tends to occur at a dough thickness of from about 0.5 mm to about 1.5 mm. These are thicknesses commonly used in tortilla manufacture. As mentioned above, the bubbles are recognized in the snack food industry as a persistent feature of tortilla style products; however this bubbling or delamination is eliminated in the practice of the present invention. Surprisingly, it has now been found that the occurrence of delamination is eliminated by scraping one or more layers from the exterior surface of the flattened dough before it is fried. The resulting scraped and fried product does not comprise a smooth surface with underlying bubbles of varying size as is formed using conventional tortilla product preparation methods. Rather, after frying the scraped surface formed by the process of the invention is not smooth, but delamination is absent. This fried surface is uniformly roughened, having the texture and granulated appearance of a very coarse grade sandpaper. Without being bound to any specific theory of operation, it is believed that this granulated texture is formed by tiny gaps in the dough form which contain water, and from which moisture vapor is evacuated as the dough is fried. There is no compressed outer layer and no bubbles are trapped beneath the surface of the dough form. As a result, the dough form retains a substantially flat profile during cooking.

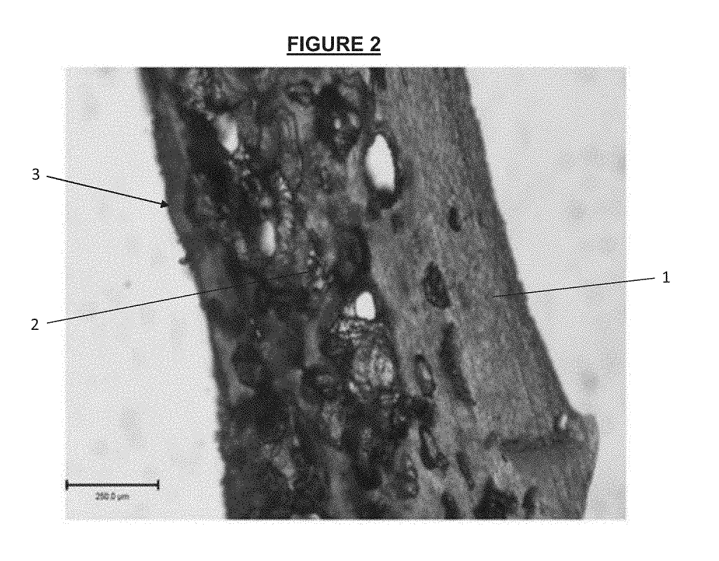

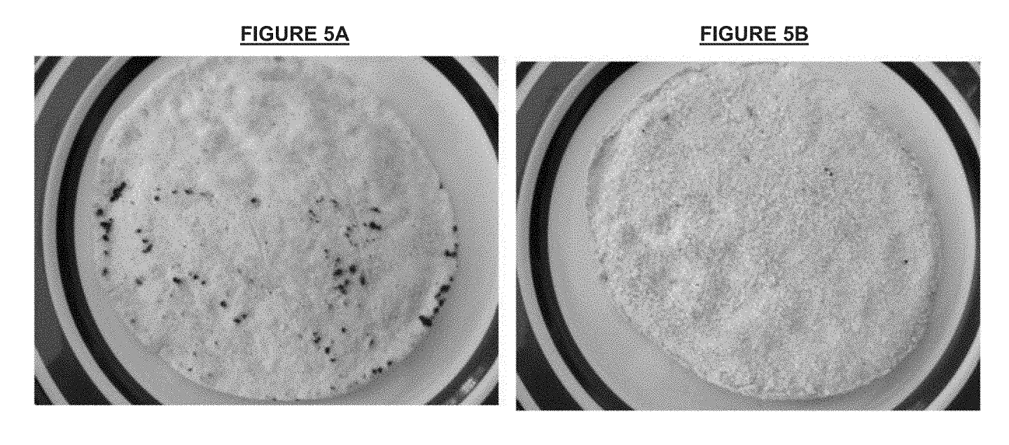

FIG. 2 shows an unfried, undried dough form that has been scraped on one side (left side of the image) in comparison to an unscraped (right side) surface having one or more compressed surface layers. Examples of the scraped and unscraped surfaces of a fried tortilla prepared according to the invention are shown in FIGS. 5A and 5B. FIG. 5A shows a fried tortilla product according to the invention in which an unscraped lamellar surface has been fried in frying oil. The puffy bubbling caused by delamination in conventional methods is not evident. FIG. 5B is an image of a fried surface of a tortilla product according to the invention in which the exterior lamellar surface was scraped before frying. The surface is uniformly roughened, with a bumpy appearance. The appearance and texture of the fried product are thus different as a result of the inventive process when compared to conventional tostada preparation.

It has also been noted that the flavor profile of the scraped tortilla product is altered because of the scraping process, in that the flavor of the corn-based product is more intense. In addition to the novel surface texture that was surprisingly observed, the overall handling feel and mouth feel of the fried product are also changed. The scraped tortilla product is crisper and more brittle after frying than conventionally fried tortilla products, and it can easily be segmented into smaller pieces, for example as chips. It may be noted that the process for frying the chip products is essentially the same; however the presently claimed invention represents a significant change in the manufacturing process before the frying step that yields a different, surprising and superior fried chip product when it is practiced. While the applicant does not wish to be bound by any particular theory or belief, it is theorized that the scraping step creates a more porous exterior scraped layer, and that this scraped layer absorbs and retains the frying oil within the interior layers of the sheeted and fried product. According to an investigation by Moreira et al., Factors Affecting Oil Uptake in Tortilla Chips in Deep-Fat Frying, the final oil content of tortilla chips was affected by moisture content and particle size distribution in the dough. It is believed that the absorption of frying oil appears to be inversely related to the moisture content of the dough form after pre-frying treatment, with a higher moisture content leading to the creation of more vacuoles or cavities into which the oil can permeate during the frying process. Therefore, a dough form with a higher moisture content would lead to a higher amount of oil being absorbed during frying. This is often visible on the exterior of the fried product. The fried product of the current invention does not display any overt oiliness on the exterior of the product after frying. It is theorized that because there is less moisture in the dough form after it has been scraped and put through the pre-frying process, the amount of moisture present in the dough form that can be replaced with oil is limited. At the same time, it is theorized that the roughly textured surface of the fried product allows increased wicking of the frying oil into the interior of the product; as well as better retention of the frying oil, which when saturated through the center layers of the dough form enhances and intensifies the overall taste and flavor profile of the finished product.

The product and process of the invention utilize a nixtamal formed from alkaline processing of maize (Zea mays, also known as corn). Preferably, high quality maize (fresh or dried), i.e. kernels cut from ears of harvested maize, is used in this process of nixtamalization. Typically, a nixtamal is prepared following a process that dates back to Mayan and Aztec cooking. In this process, corn kernels are boiled and optionally soaked in a solution of slaked lime (calcium hydroxide), ash (potassium hydroxide), lye (sodium hydroxide), lime (sodium carbonate) or combinations thereof. Historically, the alkali was obtained from natural sources such as the ashes of plants or trees or the burnt shells of crustaceans such as mussels. The alkali solution is heated to at or near boiling point and kernels of the dried maize are added. The kernels are cooked from a few minutes to an hour, and may further be soaked for minutes, hours or up to a day depending on the permeability of the kernels. During the heating and soaking process the plant cell walls of the kernels are dissolved in the alkali. The kernels become softer as the hulls are loosened and the starches begin to swell and gelatinize. Chemicals are released from the germ which improve the ability of the grains to be ground while maintaining a stable dough. The alkaline cooking fluid, known as the nejayote, is poured away.

The remaining nixtamal comprises kernels that are further processed by removal of the pericarp leaving the endosperm and germ. The removal of the pericarp is performed on a small scale by hulling by hand, or on a larger scale using specialized machines. Nixtamalization increases bioavailability of proteins and other nutrients from the endosperm of the maize kernels, such as niacin that is naturally present in bound form in maize. Niacin is an essential B-vitamin which, when omitted from the human diet, leads to development of pellagra. The process also removes 90% or more of potentially carcinogenic mycotoxins that are naturally found in stored corn as a result of mold proliferation. Nixtamal can also be obtained by enzymatic nixtamalization, in which enzymes such as proteases are added to the alkaline solution to cause the breakdown of the cell walls and dissolve the pericarp of the maize kernel. This process is typically more rapid than the conventional boiling process with lye or other alkali.

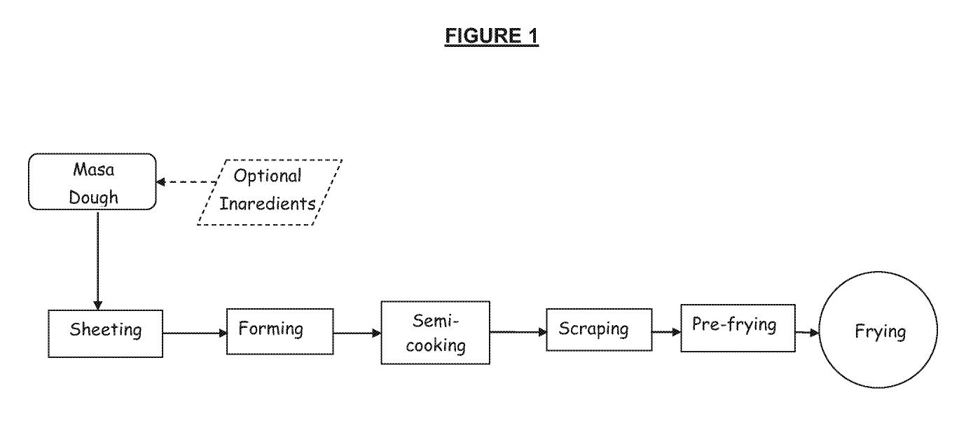

The soaked treated kernels are ground into a masa dough which contains up to 50% moisture or the dried, treated kernels are ground to varying degrees of fineness to form masa flour. Typically, the ground flour may contain particles of different sizes, which in turn contribute to the sensory mouth feel, moisture uptake and retention, and fry oil uptake in the finished product. Exemplary particle sizes may range from coarse to intermediate to fine particles, for example those which pass through higher than a number 70 sieve to those which pass through a number 100 sieve. The flour is hydrated, usually with water, to form a malleable dough that can be shaped and formed. The process of manufacture beginning with dough preparation is summarized in the schematic of FIG. 1. The presence of water in the dough serves to hydrate the proteins, provide a source of water vapor that acts as a leavening or raising agent, and also as a diluent for the various ingredients, including salt or other additives. Other ingredients can be added to the dough, such as flavorings, leavening agents and plasticizers. Typically, the dough may contain up to about 50% liquid, preferably from about 35% to about 45% moisture. The dough, which at this point should not be sticky because of excess moisture or crumbling since the flour has not been fully hydrated, is shaped and formed into balls which are flattened to form dough forms of the desired size or shape. In commercial manufacture forming may be achieved for example by passing bulk dough through sheet rollers to provide continuous sheets having an even thickness. Higher thicknesses create the propensity for scorching the exterior surfaces while rendering an undercooked central region of the tortilla product, therefore a sheet thickness of the dough from about 1.5 mm to about 3.5 mm is usually desired. The sheet is then die cut or otherwise divided to provide the selected product shapes and sizes. For example, spherical tortilla forms or strips or segments for chips can be formed. At this point the sheeted dough is essentially flat. As demonstrated by FIG. 2, the unscraped exterior surfaces of an un-dehydrated tortilla formed according to the process of the invention are generally smooth. Also as seen in FIG. 2, the unscraped exterior lamellar surface is characterized by a compact area of dough with particles more tightly pressed together and with few or no visible cavities.

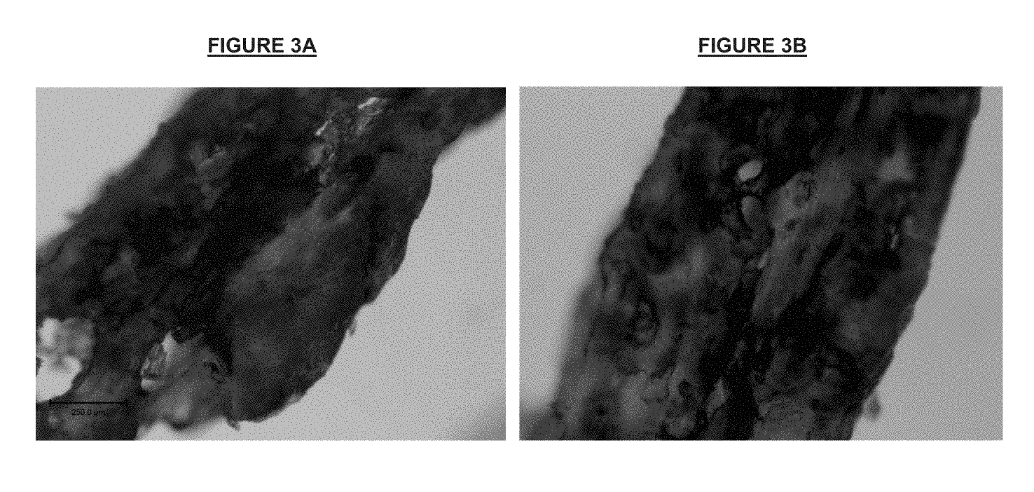

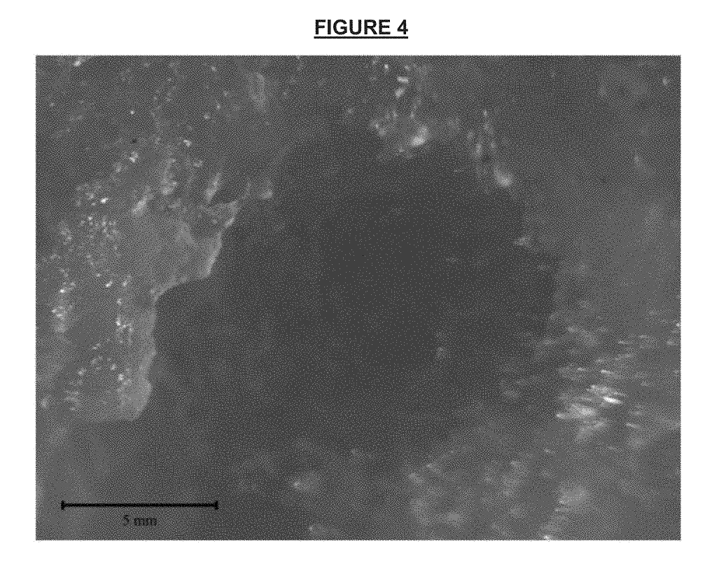

After the dough form is created, this intermediate product is characterized by a first lamellar surface and a second lamellar surface separated by a center stratum region. In a typical tortilla making process, each intact lamellar surface is a smooth and compacted layer or stratification of layers, most likely compressed by the rolling or sheeting process. FIG. 2 shows compressed exterior lamellar surface layers 1 on one side of the dough form. The scraped surface 3 lacks any compressed exterior layers. The center stratum 2 is not similarly compacted and is comprised of an arrangement of less ordered masa particles and small cavities of varying size. While the arrangement on the interior of the dough form may be somewhat irregular, this irregularity is not visible on the exterior surface. According to the novel process of the invention, a further step of scraping away at least a layer of one or both exterior lamellar surface layers is performed. This step was not previously known in conventional tortilla making or in the preparation of fried tortilla products. According to this method, a blade, knife edge, cutting wire or other horizontally positioned straight edged blade is contacted with and dragged across the exterior lamellar surface of the dough form to remove all or a significant portion of the surface layers on the selected side of the dough form. FIGS. 3A and 3B show scraped, air dried samples in which one exterior lamellar surface has been scraped to remove one or more of the compressed surface layers. FIG. 4 shows a magnified view of a sheeted, scraped and undried dough form. FIG. 2 shows a transverse section of a tortilla dough form after it has been scraped, i.e. immediately after the semi-cooking step and before it has been subjected to a pre-frying treatment such as dehydration. In this image one intact exterior lamellar surface is shown. The scraping process removes substantially all or most of the other, opposing lamellar surface to expose the center stratum.

The sheeted dough can be cut before or after scraping, for example to form chips or strips of various shapes and sizes. The dough can also be formed after scraping and before drying into shells, e.g. taco shells.

After scraping, the dough form of the invention is further subjected to a pre-frying treatment to dehydrate or otherwise prepare the dough form for frying. A suitable pre-frying treatment may be dehydration selected from air drying, toasting or heating the dough form in an oven or on a heated surface. Other pre-frying treatments may include but not be limited to spraying or dusting with flavor or color ingredients, further breaking or cutting of the form, or other treatments that would be known by one skilled in the art as applicable to the manufacture of tortilla products. Other examples of steps that may be incorporated at the pre-frying stage include application of dry ingredients such as seasonings, or spraying or brushing with liquid ingredients such as clarified butter or oil. A combination of pre-frying processes may be used, for example air drying followed by low heat in a convection oven, or vice versa. Dehydration is a preferred pre-frying treatment in the process of the invention. It is recognized that for large volume manufacture, faster dehydration times may be preferable and the mode of dehydration may be adapted accordingly. For example, dehydration on a heated plate dryer may be completed in less than 30 seconds. Depending on the pre-frying process that is used, drying times may be as little as a few seconds or up to several hours. This drying step is important to reduce the total moisture content to typically from about 20% to about 35% in the undried dough form. A higher amount of moisture could result in a change in texture, and possibly the overall fry oil uptake residual in the final product. The dehydration step should preferably not be eliminated if an optimal product is to be obtained. According to Moreira et al., the moisture content after baking (pre-frying) conventionally prepared tortillas is from about 3% to about 12% by weight.

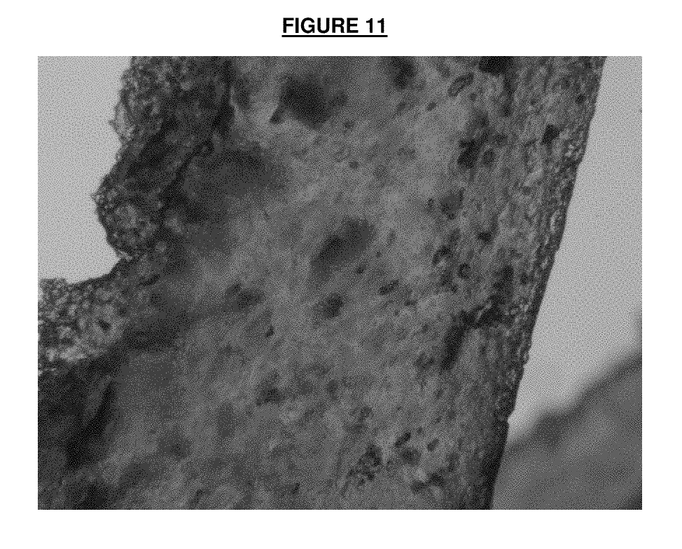

After pre-frying treatment and dehydrating, the dough form is characterized by a hardened and substantially smooth outer lamellar surface layer on the at least one unscraped side. The scraped side is not characterized by an exterior lamellar surface. As FIGS. 2, 3A and 3B indicate, a roughened, exposed interior area is provided as the outermost layer of the scraped side. In comparison, as shown in FIG. 11, the commercially available unfried tortilla exhibits distinct lamellar surface layers on either side with a defined center region containing large air pockets which cause delamination.

In the process of the invention, the dried, scraped dough forms are next fried at a temperature of from about 275° F. to about 375° F. (approximately 135 C to about 190 C). For example, the dough form can be deep fried at a temperature of about 345° F.-355° F. For deep frying, the typical frying time is less than a minute. The dough forms are fried until a crisp, golden brown product is obtained. Any conventional frying oil may be used, provided it does not affect the texture of the fried product. The dried dough forms of the invention fry much faster than a conventional tortilla. It is believed that this is because there is no exterior lamellar surface on at least one side as is the case with conventional tortillas, thus allowing easier penetration of the frying oil and of heat. This novel process thus yields these aforementioned processing advantages. For example, with conventional tortillas the frying step is typically completed in 20-40 seconds, while the dried dough forms of the invention can be fried in less than 10 seconds. Using a non-commercial deep fryer or frying pan, the frying time is about 5 seconds or less. The final appearance after frying is a dry surface texture, with no visible exterior oil retention on either the smooth or scraped surfaces of the tostada. Without wishing to be bound by any particular theory of operation as to this characteristic, it appears that because of the more open and porous nature of the scraped surface, the frying oil wicks into the small pores at the interior of the product which have been evacuated by moisture vapor during cooking. As the oil is drawn inward, a drier exterior surface is created. It is further contemplated that the product of the invention can be fried by any known frying method, for example deep-frying or air frying, and it can also be baked in a conventional oven or ovens or air fryers that rely on convectional heated air currents. It is further contemplated that adjusting the moisture content of the masa and the dried dough form could impact the frying oil absorption and retention in the fried product. Variations of the moisture content to create an optimal amount of frying oil in the final product are thus within the scope of this invention.

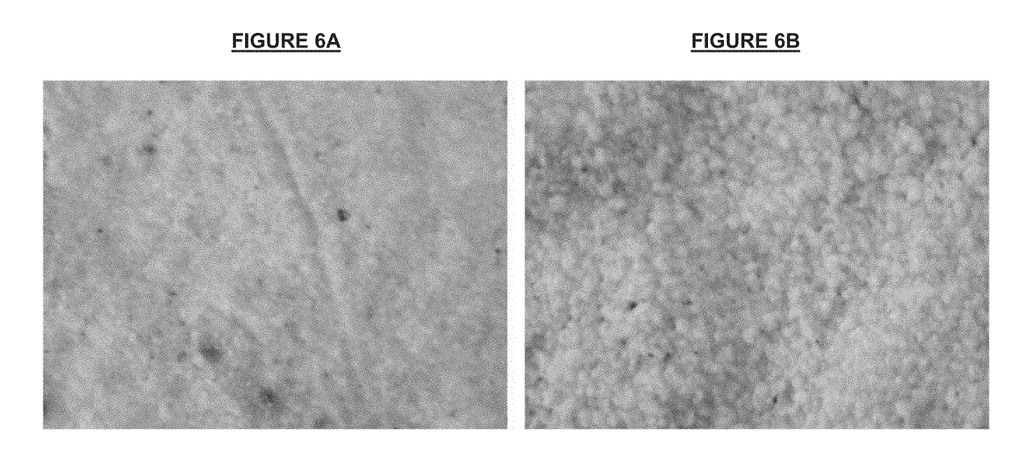

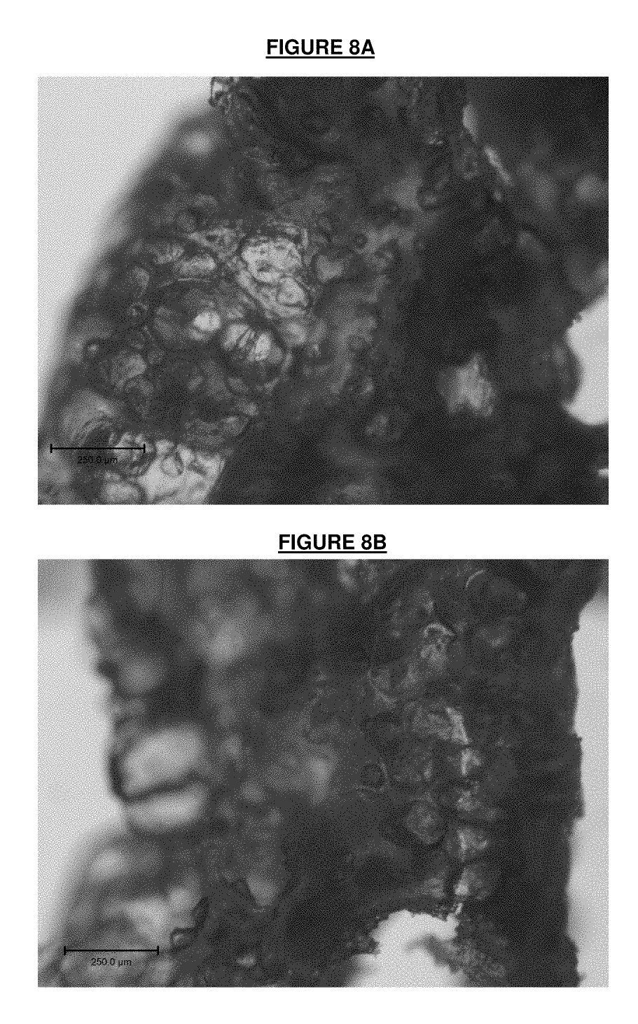

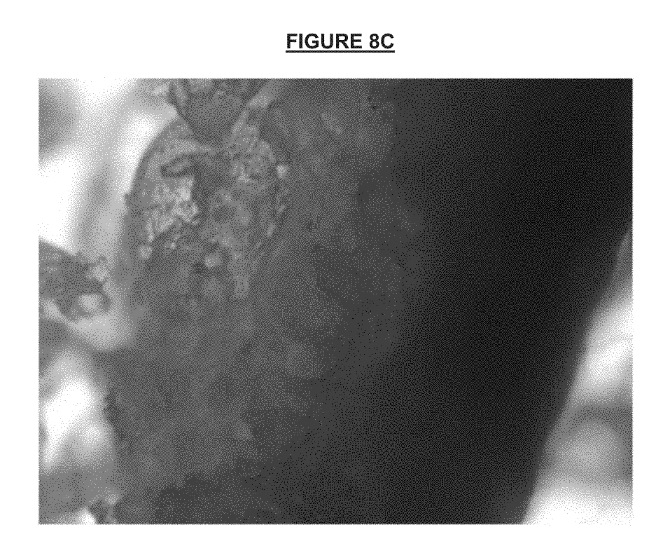

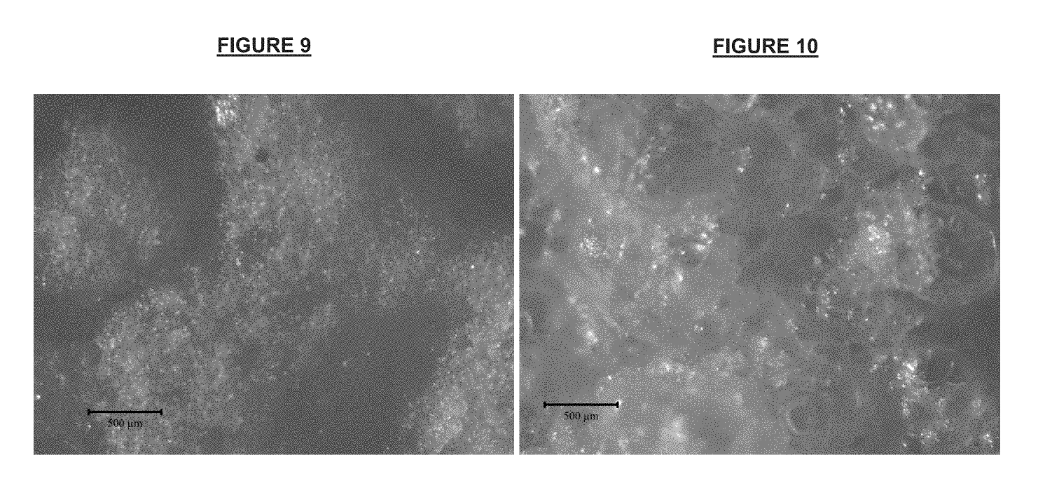

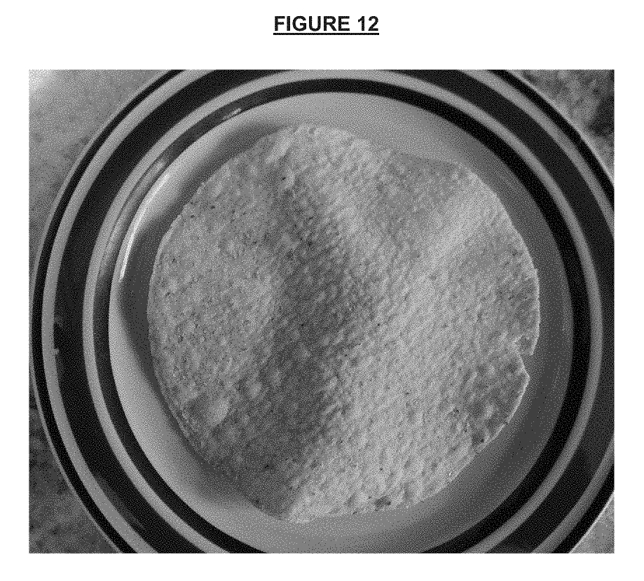

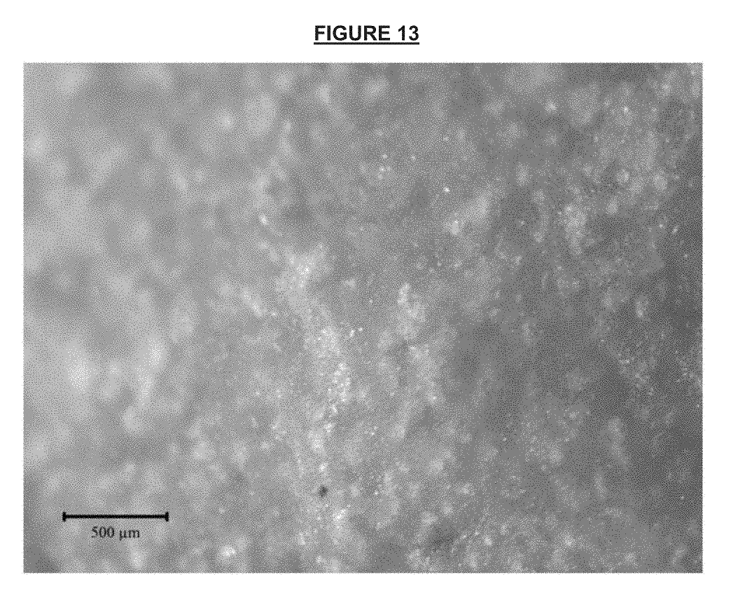

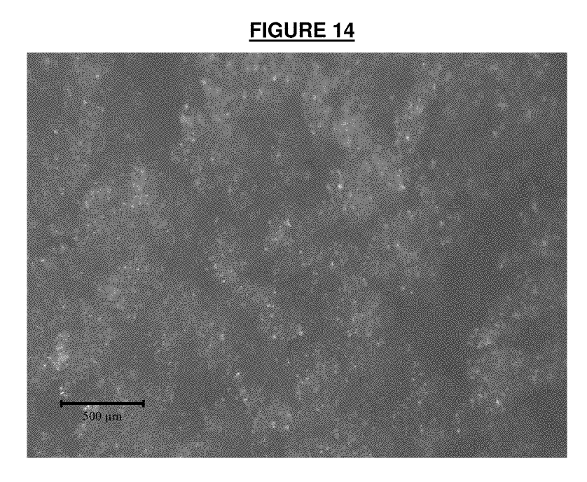

It should be noted that variables such as the type of frying oil, its viscosity and quality and the maximum oil heating temperature as well as the particle size of the masa or flour ingredient can affect the quality of the fried product. The resulting product of the invention is light, with a friable texture that provides for easy breakage. After the fried tortillas (tostadas) or chips are drained, they may be sprinkled with additional seasoning, for example with custom flavoring blends such as lime or barbeque or cheese, or otherwise left plain. Once cooled, the product can be packaged for shipment and storage. As a practical observation, it should also be noted that off the shelf tortillas are softer and more flexible than the dried dough forms of the current invention, possibly because of higher moisture content and the presence of emulsifiers and other ingredients added to retain moisture and flexibility while the product is on the shelf. They can however be fried to form a crisped product for comparative purposes. It should also be noted that in certain methods of conventional fried tortilla product manufacture, it is preferred that the moisture content be 10-20% at the point of commercial packaging so as to provide a tortilla product that is moist and flexible for consumer use, and which can be later formed and cooked by the consumer. According to the current invention, the product is fried before packaging and commercial sale, with a finished moisture content of from about 1% to about 5% by weight. After sheeting, the moisture content is in the range of about 25% to about 45% by weight. This is comparable to the typical moisture content of 30-55% weight reported by others regarding conventional tortilla manufacture. After pre-frying treatment, the moisture content of the product according to the invention is from about 6% to about 15% by weight. It should be noted that the images disclosed herein show the physical characteristics of undried, air dried, semi-cooked and fried dough forms according to the invention that reflect various levels of moisture content as the dough is processed. See FIGS. 3A, 3B, 4, 5A, 5B, 6A, 6B, 8A, 8B, 8C, 10, 12, 13 and 14. In particular, FIGS. 9 and 11 show dried conventional tortillas before frying at higher and lower magnifications. FIG. 12 shows a fried conventional tortilla that exhibits delamination. FIGS. 10. 13 and 14 show the surface characteristics of fried tortilla products of the present invention at various magnifications. It can be seen from these images that the internal structure of the dough form is more affected by the absence of a compression layer than by the hydration or processing state of the dough. Conventional tortillas are also dehydrated before frying. The advantages achieved by the process of this invention are that the final product lacks delamination and has altered and improved physical and organoleptic characteristics.

The following non-limiting examples are representative of various embodiments of the invention.

### EXAMPLE 1

In an exemplary method of manufacture on a small scale according to the process of the invention, a dough mixture for making a tostada (a fried tortilla product) is prepared from corn masa flour. In a preferred embodiment the masa is freshly prepared by boiling corn kernels in a calcium carbonate solution to form a nixtamal as described herein. The nixtamal is dried to approximately 35-45% moisture by weight and then ground to form a malleable dough by mixing with liquids, e.g. water, and optional seasonings. The dough is first extruded or otherwise sheeted to form a flattened dough form having a thickness of from about 1/16 inch to about ⅛ inch or approximately 1.5 mm to about 3.2 mm. Each side of the dough form is then par-cooked on a hot flat iron to form a tortilla, which is removed from the iron before it is fully cooked, browned or crisped. A blade or flat edge is next used to evenly scrape a layer from an outer surface of one side of the tortilla. The layer so removed is approximately 1/32 to 1/16 inch in thickness, or from about 0.08 to about 1.5 mm. The scraped tortilla is then allowed to dehydrate and harden for about 6 hours at about 80° F. The temperature and drying time can be varied provided that the conditions do not cause the dough form to be completely baked or cooked. In this embodiment, the total moisture content in the dried dough is approximately ten percent (10%) by weight.

The dried substrate is then deep fried to produce a tostada. The resulting tostada has a roughened surface on the side that was scraped before deep-frying, and the edges of the scraped side are also characterized by irregularity. The tostada product that results from frying has a distinct surface profile that is roughened with no evidence of delamination. As a result of the process of the invention, the tostada breaks more easily and has an altered and more intense flavor profile.

### EXAMPLE 2

Several samples of a masa-based dough form were tested for moisture content after sheeting, after pre-frying treatment and drying, and after frying. Sample A was taken from par-baked, undried dough form to which a scraping process had been applied according to the invention. Sample B also consisted of a par baked dough form sampled after scraping and dehydration (pre-frying) according to the invention. Sample C was taken from a fried and cooled tostada prepared according to the invention.

To determine moisture content, each sample was weighed to determine the initial weight and then subjected to a dessication process at 90° C. for the duration specified in Table 1 below. The dessication endpoint was automatically determined by the moisture analyzers once the rate of weight change reached zero. The undried dough form required additional time to completely dry the sample to endpoint. An ending weight was recorded and the amount of moisture lost during the pre-frying process was calculated as weight percentage. The results are shown in Table 1.

TABLE 1

| | | | | Time to |
|---|---|---|---|---|
| | | | | complete |
| | | Drying Temp | Measure- | Test |
| Sample | Description | (90° Celsius) | ments | (minutes) |
| Sample A | Par baked, | Initial Weight (grams) | 2.997 | |
| | undried | Ending Weight | 2.126 | |
| | tortilla | (grams) | | |
| | | Moisture Content (Δ) | 29.1% | 23:09 |
| Sample B | Par baked, | Initial Weight (grams) | 3.321 | |
| | dried tortilla | Ending Weight | 2.876 | |
| | | (grams) | | |
| | | Moisture Content (Δ) | 13.4% | 17:21 |
| Sample C | Fried tostada | Initial Weight (grams) | 2.904 | |
| | | Ending Weight | 2.869 | |
| | | (grams) | | |
| | | Moisture Content (Δ) | 1.21% | 17:21 |

These results indicate that semi cooked and dried dough forms according to the invention, i.e. the dried dough form before frying, displayed a moisture content of approximately 13.4% by weight. After frying, a moisture content of about 1.2% weight was obtained.

### EXAMPLE 3

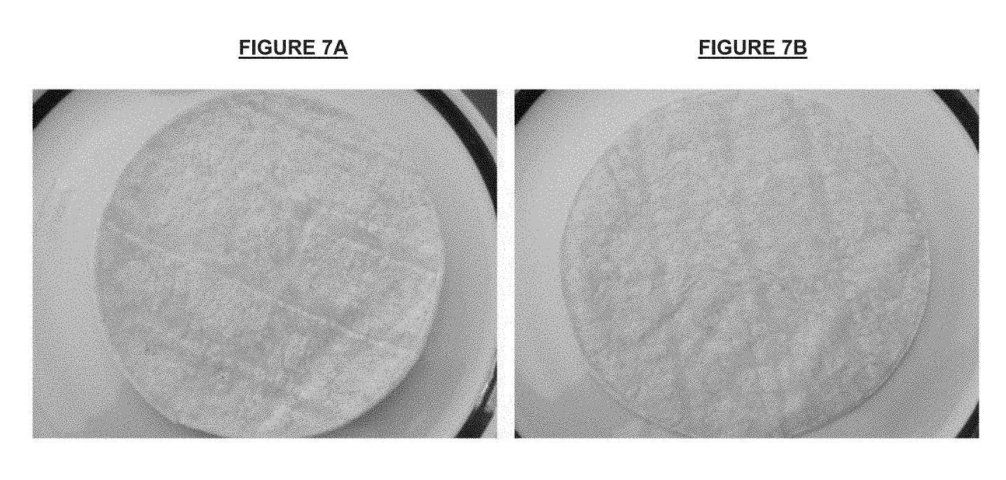

Photographic images of thinly cut cross sections of dough forms and a fried tostada product were captured using standard high resolution microscopy equipment. These included a Leica MZ6 stereoscope at 1.0× magnification and a Leica DM LB compound microscope at 10× magnification. Both microscopes were fitted with digital cameras manufactured by Spot Imaging Inc. Other comparative images were captured using a consumer grade Nikon digital camera. The operating parameters for imaging of the samples represented by the applicable accompanying figures (FIGS. 2-14 described hereinabove) are as set forth in Table 2 below.

TABLE 2

| | | Magnification/ | |
|---|---|---|---|
| FIG. No. | Microscope | Scale | Other |
| 2 | compound | 10X | |
| | microscope | | |
| | Leica DM LB | | |
| 3A, 3B | compound | 10X | |
| | microscope | | |
| | Leica DM LB | | |
| 4 | stereoscope | 1.0X | |
| | Leica MZ6 | | |
| 5A, 5B | | 1.0X | Nikon Digital Camera |
| 6A, 6B | | 1.0X | Nikon Digital Camera |
| 7A, 7B | | 1.0X | Nikon Digital Camera |
| 8A, 8B, 80 | compound | 10X | |
| | microscope | | |
| | Leica DM LB | | |
| 9 | stereoscope | 1.0X | |
| | Leica MZ6 | | |
| 10 | stereoscope | 1.0X | |
| | Leica MZ6 | | |
| 11 | compound | 10X | |
| | microscope | | |
| | Leica DM LB | | |
| 12 | | 1.0X | Nikon Digital Camera |
| 13 | stereoscope | 1.0X | |
| | Leica MZ6 | | |
| 14 | stereoscope | 1.0X | |
| | Leica MZ6 | | |
| 15 | stereoscope | 1.0X | |
| | Leica MZ6 | | |

### EXAMPLE 4

Commercially marketed fried tostada chips and a fried tostada chip product according to the invention were subjected to blind taste testing by a total of five (5) tasters. Sample 1 consisted of conventional, commercially packaged tortilla chips manufactured by Frito Lay, Inc. and marketed under the brand name SANTITAS® Yellow Corn Tortilla Chips. Sample 2 consisted of tortilla chips prepared by the method of the invention, in which the dough form was subjected to scraping before drying and then frying. Sample 3 consisted of conventional, commercially packaged tortilla chips manufactured by Frito Lay, Inc. and marketed under the brand name TOSTITOS® Original Restaurant Style Tortilla Chips. The tasters scored the products according to a subjective, comparative assessment of flavor quality by selecting the most preferred product. The selected product was assigned a numeric value of one (1); non-selected samples were assigned a score of zero (0). A cumulative score was then computed for each product. The results are shown in Table 3.

TABLE 3

| Tester | Sample 1 | Sample 2 | Sample 3 |
|---|---|---|---|
| 1 | 0 | 1 | 0 |
| 2 | 0 | 1 | 0 |
| 3 | 0 | 1 | 0 |
| 4 | 0 | 1 | 0 |
| 5 | 0 | 1 | 0 |
| Cumulative Score | 0 | 5 | 0 |

### INDUSTRIAL APPLICABILITY

The method of the invention has utility in the production of foods such as tortilla products and other products based on dough forms made from grain or glutenous or non-glutenous flours. The products of the invention are comestibles that have a wide range of applications in various cuisines.

The foregoing specification and examples provide an enabling description of the method of manufacture and comestible products of the invention. Many embodiments can be made without departing from the spirit and scope of the invention and this disclosure, including those represented by the appended claims.

1. A method of making a tortilla product comprising:
a. formulating a dough that includes a flour ingredient;
b. shaping and flattening the dough into a dough form comprised of a first lamellar surface, a second lamellar surface, and a central stratum between the first lamellar surface and the second lamellar surface;
c. semi-cooking the dough form;
d. scraping at least a layer from the first lamellar surface of the dough form, to form at least one scraped surface;
e. applying a pre-frying treatment to the dough form; and
f. frying the dough form to form a tortilla product wherein after frying the at least one scraped surface is characterized by a uniformly roughened surface profile without delamination.

2. The method of claim 1 wherein the step of scraping is performed with a blade.

3. The method of claim 2 wherein the blade is a straight-edged blade.

4. The method of claim 1 wherein the dough is prepared from nixtamalized maize, dried masa flour, a glutenous flour, a grain flour or combinations thereof.

5. The method of claim 1, further comprising scraping at least a layer from the second lamellar surface of the dough form to form a second scraped surface.

6. The method of claim 1 wherein the dough form is dried at a temperature of from about 25° C. to about 200° C. to achieve a moisture level of from about 6% to about 15% without cooking the dough form.

7. The method of claim 6 wherein the temperature range for frying is from about 130° C. to about 190° C.

8. The method of claim 1 wherein the dough form is dried to a moisture content of from approximately 5% to approximately 20% by weight.

9. The method of claim 1 wherein the tortilla product is selected from tostadas, chips, shells and bowls.

10. A process of making tortillas comprising:
a. formulating a dough that includes a flour ingredient;
b. shaping and flattening the dough into a dough form comprised of a first lamellar surface, a second lamellar surface, and a central stratum between the first lamellar surface and the second lamellar surface;
c. semi-cooking the dough form; and
d. scraping at least a layer from the first or second lamellar surface of the dough form, to form at least one scraped surface.

11. A tortilla product formed by the method of claim 1.

12. A fried tortilla product formed from a dough, the product comprising two flattened surfaces, wherein at least one surface thereof is a roughened surface that exhibits no delamination, and further wherein said roughened surface has been formed by a process that includes scraping at least a layer from a surface of the dough form before it is fried.

13. The fried tortilla product of claim 12 wherein both flattened surfaces have been treated by the scraping process.

14. The product of claim 12 which is a snack food such as a tostada, chip or shell.

15. The fried tortilla product of claim 12 wherein the at least one roughened surface is comprised of substantially uniform arrangement of small dough particles and gaps between the particles.

16. The fried tortilla product of claim 12 wherein the dough has been dried after scraping and before frying by air drying or by exposure to heat.

17. The fried tortilla product of claim 13 wherein both roughened surfaces have been dried after scraping and before frying by air drying or by exposure to heat.

18. The fried tortilla product of claim 12 wherein the dough was prepared from nixtamalized maize, dried masa flour, a glutenous flour, a grain flour or combinations thereof.

19. The fried tortilla product of claim 12 wherein the exterior surface of the product exhibits no visible oil retention.

20. A tortilla formed by the process of claim 10.
